(19) United States
(12) Patent Application Publication
(10) Pub. No.: US 2011/0021151 A1
(43) Pub. Date: Jan. 27, 2011

(54) MOBILE TERMINAL DEVICE, INFORMATION DELIVERY DEVICE, INFORMATION DELIVERY SYSTEM, AND INFORMATION DELIVERY METHOD

(75) Inventor: Hiroshi Takekawa, Tokyo (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/933,824

(22) PCT Filed: Apr. 8, 2009
(86) PCT No.: PCT/JP2009/001636

§ 371 Date: Sep. 21, 2010

(30) Foreign Application Priority Data
Apr. 8, 2008 (JP) 2008-100596

(51) Int. Cl. H04B 7/00

(52) U.S. Cl. 455/41.2

(57) ABSTRACT

Provided is an information distribution system having a simple configuration and capable of selecting information without inconvenience to the user. A mobile terminal device (100) is equipped with a terminal side communication section (101) for performing directional short range wireless communication with an information distribution device (200). A control section (102) determines, based on the communication sensitivity of the terminal side communication section (101), an operation by the user and controls, based on the determined operation information of the user, the continuation and termination of the information acquisition by the terminal side communication section (101) and issuing of a new information acquisition request to the information distribution device (200). An operation acknowledgement section (202) of the information distribution device (200) acknowledges the operation by the user from a communication content received by a distribution-side communication section (201). An information selection section (203) selects, based on the acknowledgement result, distribution information that an information read section (204) reads from an information storage section (205). The distribution-side communication section (201) transmits the selected distribution information to the mobile terminal device (100).

### TECHNICAL FIELD

The present invention relates to a mobile terminal apparatus, information distribution apparatus, information distribution system, and information distribution method.

### BACKGROUND ART

In recent years, mobile communication terminals such as mobile phone terminals have become more versatile through the provision of various radio functions (such as infrared communication, FeliCa (registered trademark), Bluetooth (registered trademark), and One Seg (one-segment broadcasting)) in addition to speech and suchlike communication functions.

Furthermore, WLANs (Wireless Local Area Networks), Bluetooth (registered trademark), UWB (Ultra Wideband), and the like are used as systems capable of accessing a local network as well as a carrier. WLANs are widely used by portable notebook PCs provided with a WLAN function, and mobile information terminals such as PDAs (Personal Digital Assistants). In the field of mobile phones, with their requirement of low power consumption, low-power, short-range, bidirectional radio communication systems such as above-mentioned Bluetooth and UWB are attracting attention.

In the past, an infrared communication, Bluetooth (registered trademark), or suchlike short-range radio interface has mainly been used for communication between a mobile terminal and a peripheral device or the like. However, in recent years, the distribution of discount coupons, store information, and so forth, via a short-range radio interface has become increasingly common, and communication speeds have also improved.

Patent literature 1 describes an advertising information provision system that accepts information distribution.

FIG. 1 is a flowchart showing the operation of an information issuing apparatus described in Patent literature 1.

As shown in FIG. 1, in step S1 a receiving section of the information issuing apparatus receives an access request signal from a mobile device.

In step S2, an information processing section of the information issuing apparatus determines whether an information access has occurred, and proceeds to step S3 if an information access has occurred, or terminates the processing flow if an information access has not occurred.

In step S3, the above information processing section acquires information comprising the current date, time, and temperature based on output information from a clock circuit and sensor.

In step S4, the above information processing section selects transmission information (code information for identifying an advertisement) based on the date and time information and temperature information acquired in step S3.

In step S5, a transmitting section of the information issuing apparatus issues the advertising information selected in above step S4.

By this means, a user can obtain transmission information simply by holding a mobile terminal close to the above information issuing apparatus, and can obtain information based on a date, time, and temperature.

### CITATION LIST

Patent Literature PTL 1: Patent literature 1: Japanese Patent Application Laid-Open No. 2002-72942

### SUMMARY OF INVENTION

### Technical Problem

However, with a mobile terminal apparatus that accepts information distribution by means of a conventional short-range radio interface of this kind, although different information can be provided according to usage conditions, there is no scope for selection of distributed information by a user, and a user cannot select a variety of desired information.

While a user could be offered a choice of information by being presented with a menu, there are problems with adopting a method whereby a menu is displayed on a mobile terminal apparatus and the user makes a selection, as follows. In general, while mobile devices are designed for ease of carrying around, their operability is often limited. From the viewpoint of a user wishing to obtain information by means of a simple operation while on the move outdoors, carrying out a predetermined operation on a mobile device with limited operability is inconvenient. Also, while operability can be improved by providing a dedicated input/output apparatus for menu display, the need for this input/output apparatus increases costs, and securing space for installing such an input/output apparatus in a small housing is difficult.

It is therefore an object of the present invention to provide a mobile terminal apparatus, information distribution apparatus, information distribution system, and information distribution method that make information selection possible with a simple configuration, without inconvenience to a user.

### Solution to Problem

A mobile terminal apparatus of the present invention employs a configuration having: a short-range radio communication section that performs directional short-range radio communication with an information distribution apparatus; a display section that displays information received by the short-range radio communication section; and a control section that determines a user operation based on communication sensitivity of the short-range radio communication section, and, based on determined user operation information, controls continuation and termination of information acquisition by the short-range radio communication section, and issuance of a new information acquisition request to the information distribution apparatus.

A mobile terminal apparatus of the present invention employs a configuration having: a short-range radio communication section that performs directional short-range radio communication with an information distribution apparatus; a display section that displays information received by the short-range radio communication section; an operation recognition section that recognizes a user operation based on communication sensitivity of the short-range radio communication section, and, based on recognized user operation information, controls continuation and termination of information acquisition by the short-range radio communication section, and issuance of a new information acquisition request to the information distribution apparatus; a latest acquisition time history recording section that records the latest acquisition time of information from the information distribution apparatus; a communication interval calculation section that calculates the latest communication interval with the information distribution apparatus; a latest start time history recording section that records a start time at which the latest communication with the information distribution apparatus was started; and a duration calculation section that calculates the duration of the latest communication with the information distribution apparatus, wherein the operation recognition section recognizes a user operation based on the information acquisition time, the communication interval, the communication start time, and the duration.

An information distribution apparatus of the present invention employs a configuration having: an information storage section that stores distribution information; a short-range radio communication section that performs directional short-range radio communication with a mobile terminal apparatus; an operation recognition section that recognizes a user operation from communication contents received by the short-range radio communication section; and an information selection section that selects distribution information stored in the information storage section based on a recognition result of the operation recognition section, wherein the short-range radio communication section transmits distribution information selected by the information selection section to the mobile terminal apparatus.

An information distribution apparatus of the present invention employs a configuration having: an information storage section that stores distribution information; a short-range radio communication section that performs directional short-range radio communication with a mobile terminal apparatus; and an information selection section that selects distribution information stored in the information storage section in accordance with a request from the mobile terminal apparatus, wherein the short-range radio communication section transmits distribution information selected by the information selection section to the mobile terminal apparatus.

An information distribution system of the present invention is an information distribution system having a mobile terminal apparatus and an information distribution apparatus that distributes information in response to a request from the mobile terminal apparatus, wherein the mobile terminal apparatus has a short-range radio communication section that performs directional short-range radio communication with an information distribution apparatus, a display section that displays information received by the short-range radio communication section, and a control section that determines a user operation based on communication sensitivity of the short-range radio communication section, and, based on determined user operation information, controls continuation and termination of information acquisition by the short-range radio communication section, and issuance of a new information acquisition request to the information distribution apparatus; the information distribution apparatus has an information storage section that stores distribution information, a distribution-side short-range radio communication section that performs directional short-range radio communication with the mobile terminal apparatus, an operation recognition section that recognizes a user operation from communication contents received by the distribution-side short-range radio communication section, and an information selection section that selects distribution information stored in the information storage section based on a recognition result of the operation recognition section; and the distribution-side short-range radio communication section transmits distribution information selected by the information selection section to the mobile terminal apparatus.

An information distribution method of the present invention is an information distribution method of distributing information from an information distribution apparatus in response to a request from a mobile terminal apparatus; this method having, on the mobile terminal apparatus side, performing directional short-range radio communication with the information distribution apparatus, displaying information received by means of the short-range radio communication, determining a user operation based on communication sensitivity of the short-range radio communication, and controlling, based on determined user operation information, continuation and termination of information acquisition by the short-range radio communication section, and issuance of a new information acquisition request to the information distribution apparatus; and having, on the information distribution apparatus side, storing distribution information, performing directional short-range radio communication with the mobile terminal apparatus, recognizing a user operation from communication contents received by means of the short-range radio communication, selecting stored distribution information based on the recognition result, and transmitting selected distribution information to the mobile terminal apparatus.

### ADVANTAGEOUS EFFECT OF INVENTION

The present invention has an effect of simplifying viewing and selection of information by a user in information distribution using short-range radio communication by recognizing an operation easily performed by the user as an operation in a mobile terminal apparatus or information distribution apparatus. For example, what kind of processing is required can be recognized from user operations of holding up/removing/continuously holding up a mobile terminal apparatus, and viewing of an information summary and selection of desired information can easily be performed. Therefore, information selection can be made possible without inconvenience to a user and with an inexpensive information distribution apparatus configuration.

### BRIEF DESCRIPTION OF DRAWINGS

FIG. 1 is a flowchart showing the operation of a conventional information issuing apparatus;

FIG. 2 is a block diagram showing configurations of a mobile terminal apparatus and an information distribution apparatus according to Embodiment 1 of the present invention;

FIG. 3 is a drawing showing an example of the data structure of a latest information distribution history recorded in a latest information distribution history recording section of a mobile terminal apparatus and an information distribution apparatus according to Embodiment 1;

FIG. 4 is a drawing showing an example of the data structure of a latest acquisition time history recorded in a latest acquisition time history recording section of a mobile terminal apparatus and an information distribution apparatus according to Embodiment 1;

FIG. 5 is a drawing showing an example of the data structure of a latest start time history recorded in a latest start time history recording section of a mobile terminal apparatus and an information distribution apparatus according to Embodiment 1;

FIG. 6 is a flowchart showing the operation of a mobile terminal apparatus and an information distribution apparatus according to Embodiment 1;

FIG. 7 is a block diagram showing configurations of a mobile terminal apparatus and an information distribution apparatus according to Embodiment 2 of the present invention;

FIG. 8 is a drawing showing an example of the data structure of a terminal-side latest acquisition time history recorded in a terminal-side latest acquisition time history recording section of a mobile terminal apparatus and an information distribution apparatus according to Embodiment 2;

FIG. 9 is a drawing showing an example of the data structure of a terminal-side latest start time history recorded in a terminal-side latest start time history recording section of a mobile terminal apparatus and an information distribution apparatus according to Embodiment 2; and

FIG. 10 is a flowchart showing the operation of a mobile terminal apparatus and an information distribution apparatus according to Embodiment 2.

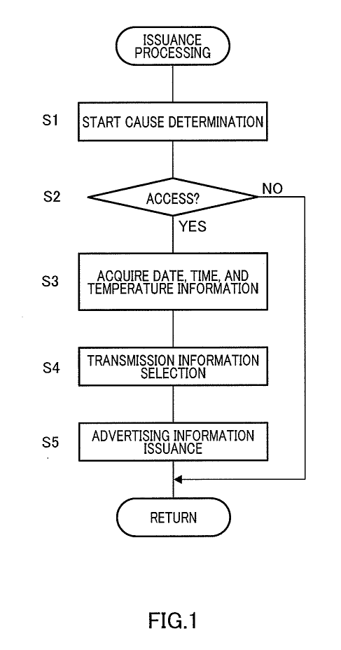

### DESCRIPTION OF EMBODIMENTS

Now, embodiments of the present invention will be described in detail with reference to the accompanying drawings.

### Embodiment 1

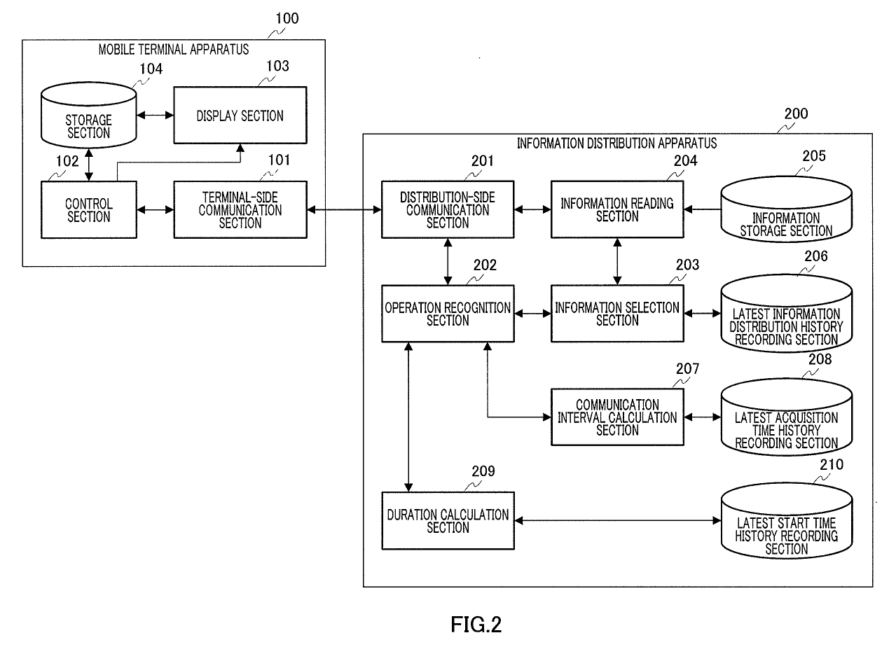

FIG. 2 is a block diagram showing configurations of a mobile terminal apparatus and an information distribution apparatus according to Embodiment 1 of the present invention. This embodiment is an example of the use of a mobile phone provided with a short-range radio communication function as a mobile terminal apparatus.

In FIG. 2, an information distribution system comprises mobile terminal apparatus 100 provided with a short-range radio communication function, and information distribution apparatus 200 that distributes information to mobile terminal apparatus 100 by means of a short-range radio communication function.

Mobile terminal apparatus 100 comprises terminal-side communication section 101, control section 102, display section 103, and storage section 104.

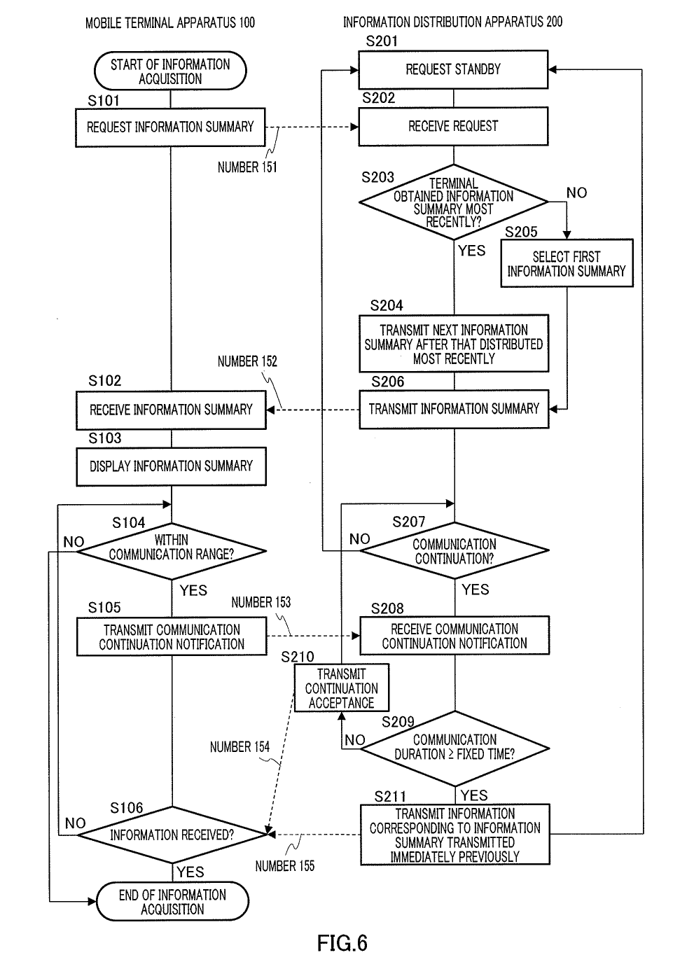

Information distribution apparatus 200 comprises distribution-side communication section 201, operation recognition section 202, information selection section 203, information reading section 204, information storage section 205, latest information distribution history recording section 206, communication interval calculation section 207, latest acquisition time history recording section 208, duration calculation section 209, and latest start time history recording section 210. Operation recognition section 202, information selection section 203, information reading section 204, communication interval calculation section 207, and duration calculation section 209 comprise a CPU (Central Processing Unit) or the like, and the CPU performs overall apparatus control, and executes the processing in FIG. 6 described later herein, using semiconductor memory such as ROM (Read-Only Memory) storing a control program, fixed data, and so forth, and RAM (Random Access Memory) functioning as a working storage area for the CPU (neither of which is shown).

Examples of mobile terminal apparatus 100 include (1) a mobile phone/PHS (Personal Handy-Phone System), (2) a mobile terminal such as a mobile information terminal (hereinafter referred to as PDA (Personal Digital Assistant)), (3) a notebook PC, and (4) a portable game machine. Basic mobile phone function sections when mobile terminal apparatus 100 is applied to a mobile phone—for example, an antenna and radio communication section for performing carrier communication with a base station—are not shown.

Terminal-side communication section 101 performs directional short-range radio communication with distribution-side communication section 201 of information distribution apparatus 200. Specifically, terminal-side communication section 101 uses directional communication such as infrared or millimeter wave UWB, contactless communication allowing the communication range to be restricted to a comparatively narrow range, or the like, as a radio communication method. Examples of contactless communication are IrDA (Infrared Data Association) and FeliCa (registered trademark) ICs. Low-power, short-range, bidirectional radio communication systems such as Bluetooth (registered trademark) and UWB (not millimeter wave UWB) are not suitable as a short-range radio communication function of this embodiment since they are not extremely directional with respect to information distribution apparatus 200. That is to say, a feature of a short-range radio communication function of this embodiment is utilization of the fact that communication sensitivity varies as a user performs an operation such as holding up or removing mobile terminal apparatus 100, and control section 102 determines a user operation based on this communication sensitivity. In general, Bluetooth (registered trademark) and UWB (not millimeter wave UWB) provided in mobile terminal apparatus 100 have a non-directional configuration so that communication is not interrupted in various communication environments. However, when this mode is used, it is possible to provide directivity by employing antenna switching, suitable shielding measures, or the like, in which case Bluetooth (registered trademark), UWB (not millimeter wave UWB), and the like can be used.

Control section 102 comprises a CPU or the like, and the CPU performs overall apparatus control, and executes the processing in FIG. 6 described later herein, using semiconductor memory such as ROM storing a control program, fixed data, and so forth, and RAM functioning as a working storage area for the CPU (neither of which is shown).

Control section 102 determines a user operation based on communication sensitivity of terminal-side communication section 101, and, based on determined user operation information, controls continuation and termination of information acquisition by terminal-side communication section 101, and issuance of a new information acquisition request to information distribution apparatus 200.

Display section 103 comprises a dot-matrix type, LCD display capable of color-display, an EL (Electro Luminescence) white LED backlight, drivers, and so forth, and performs color display of information received by terminal-side communication section 101.

Storage section 104 comprises semiconductor memory, a hard disk, or the like, and stores information received by terminal-side communication section 101.

Here, parts configuring mobile terminal apparatus 100 can be shared by devices configuring a so-called mobile phone, and mobile terminal apparatus 100 can be implemented as one form of a mobile information terminal such as a mobile phone/PHS or PDA. If mobile terminal apparatus 100 takes a form in which it is incorporated into a mobile phone or suchlike mobile terminal, control section 102 executes this information acquisition processing using system CPU resources. Storage section 104 may also be, for example, an SRAM (Static RAM) card, holding information written by means of power supply backup, or an SD card or CompactFlash (registered trademark) (CF), comprising flash memory that does not require power supply backup.

On the other hand, information distribution apparatus 200 is an access point/hotspot for short-range radio communication, so to speak, installed at various locations, and its control section can also be implemented by a software program using the CPU and memory of a personal computer. Information distribution apparatus 200 may also be a server that distributes commercial content information.

Distribution-side communication section 201 of information distribution apparatus 200 performs short-range radio communication with terminal-side communication section 101 of mobile terminal apparatus 100. In the same way as terminal-side communication section 101 of mobile terminal apparatus 100, distribution-side communication section 201 uses directional communication such as infrared or millimeter wave UWB, contactless communication allowing the communication range to be restricted to a comparatively narrow range, or the like. Distribution-side communication section 201 transmits information received from information reading section 204, and passes information received from mobile terminal apparatus 100 to operation recognition section 202.

Operation recognition section 202 performs user operation recognition based on data received from distribution-side communication section 201, communication interval calculation section 207, and duration calculation section 209. In user operation recognition, communication sensitivity is varied by user operations such as holding up or removing mobile terminal apparatus 100, and an operation is recognized that directs continuation and termination of information acquisition by terminal-side communication section 101, and issuance of a new information acquisition request to information distribution apparatus 200.

Information selection section 203 selects information to be transmitted based on a result in operation recognition section 202 and a latest information distribution history recorded in latest information distribution history recording section 206.

Information reading section 204 reads information stored in information storage section 205 according to specification by information selection section 203.

Information storage section 205 stores an information summary and corresponding information in an associated fashion for each kind of information, and an information ID is assigned to each such pair. Here, “each kind of information” means leaflets, video, distributed information, content, and so forth, and “information summary” means a summary of corresponding information, or a summary for use in determination for selecting information. For example, if the kind of information is “leaflet,” an information summary is the “title” thereof, and if the kind of information is “video,” an information summary is a still image of a digest thereof.

Latest information distribution history recording section 206 records information last transmitted to mobile terminal apparatus 100 as a latest information distribution history.

Communication interval calculation section 207 calculates a communication interval using a latest information distribution history of latest acquisition time history recording section 208.

Latest acquisition time history recording section 208 records a time at which an information summary was last transmitted to mobile terminal apparatus 100 as a latest acquisition time history.

Duration calculation section 209 calculates the duration of communication using a latest start time history in latest start time history recording section 210.

Latest start time history recording section 210 records a time at which communication was last started with mobile terminal apparatus 100 as a latest start time history.

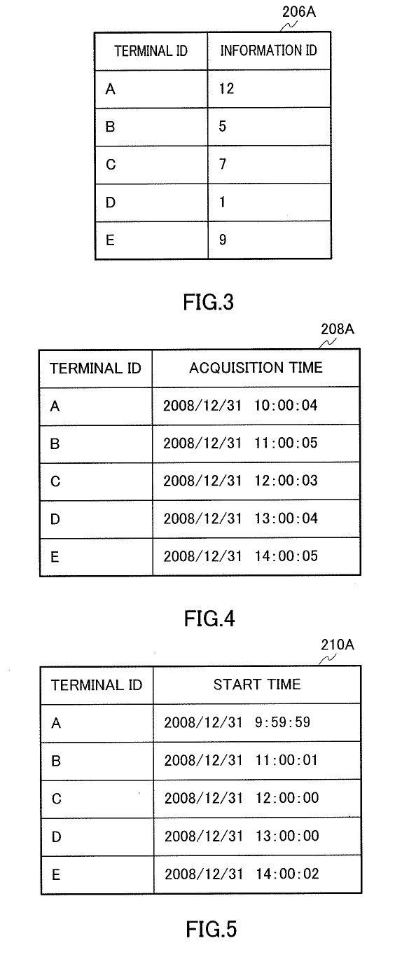

FIG. 3 is a drawing showing an example of the data structure of a latest information distribution history recorded in latest information distribution history recording section 206.

In FIG. 3, latest information distribution history 206A is table data comprising terminal ID/information ID pairs, in which the information ID of an information summary last transmitted to a mobile terminal apparatus indicated by a terminal ID is recorded. For example, the first line in FIG. 3 shows that the information ID of an information summary last transmitted to a mobile terminal apparatus whose terminal ID is “A” is “12.” The above information IDs are assigned to kind of information/information summary pairs, and if “leaflet” is “12” and “video” is “13” among the kinds of information, the first line in FIG. 3 indicates that “leaflet” was transmitted last.

FIG. 4 is a drawing showing an example of the data structure of a latest acquisition time history recorded in latest acquisition time history recording section 208.

In FIG. 4, latest acquisition time history 208A records a terminal ID and a time at which a mobile terminal apparatus corresponding to that terminal ID last acquired an information summary. For example, the first line in FIG. 4 shows that the time at which a mobile terminal apparatus whose terminal ID is “A” last acquired an information summary is “2008/12/31 10:00:04.”

FIG. 5 is a drawing showing an example of the data structure of a latest start time history recorded in latest start time history recording section 210.

In FIG. 5, latest start time history 210A records a terminal ID and a time at which a mobile terminal apparatus corresponding to that terminal ID last started communication. For example, the first line in FIG. 5 shows that the time at which a mobile terminal apparatus whose terminal ID is “A” last started communication is “2008/12/31 9:59:59.”

The operation of mobile terminal apparatus 100 and information distribution apparatus 200 configured as described above will now be explained.

FIG. 6 is a flowchart showing the operation of mobile terminal apparatus 100 and information distribution apparatus 200. In FIG. 6, reference codes S101 through S106 indicate operations on the mobile terminal apparatus 100 side, and reference codes S201 through S211 indicate operations on the information distribution apparatus 200 side. Numbers 151 through 155 indicate signal transmission/reception between mobile terminal apparatus 100 and information distribution apparatus 200. The flowchart in FIG. 6 is executed by control section 102 of mobile terminal apparatus 100 and a control section comprising a CPU or the like (not shown) of information distribution apparatus 200.

First, when the user holds mobile terminal apparatus 100 close to information distribution apparatus 200 and starts communication, information acquisition starts.

In step S101, mobile terminal apparatus 100 makes a request for an information summary to information distribution apparatus 200. Specifically, terminal-side communication section 101 of mobile terminal apparatus 100 makes a request for an information summary to distribution-side communication section 201 of information distribution apparatus 200 by means of short-range radio communication (see number 151).

When not communicating with any mobile terminal, information distribution apparatus 200 is in a request standby state (step S201).

When mobile terminal apparatus 100 transmits an information summary request in step S101, in step S201 information distribution apparatus 200 receives the information summary request and updates latest start time history recording section 210. Specifically, distribution-side communication section 201 of information distribution apparatus 200 receives an information summary request from terminal-side communication section 101 of mobile terminal apparatus 100. Then latest start time history recording section 210 updates latest start time history 210A based on the time at which distribution-side communication section 201 received the information summary request by means of short-range radio communication (that is, the time at which mobile terminal apparatus 100 last started communication).

In step S203, communication interval calculation section 207 of information distribution apparatus 200 determines whether or not mobile terminal apparatus 100 has obtained an information summary most recently. Specifically, communication interval calculation section 207 calculates a communication interval from the latest acquisition time history of latest acquisition time history recording section 208 and the current time, compares this communication interval with a threshold value, and if the communication interval is greater than or equal to the threshold value, determines that information summary acquisition is not the latest. This threshold value may be fixed beforehand, or may be varied according to the situation. If there is no history, communication interval calculation section 207 determines that an information summary has not been obtained most recently. For example, referring to FIG. 4, if a mobile terminal apparatus whose terminal ID is “E” starts communication, and the time when the communication interval is calculated is “2008/12/31 10:00:15,” the communication interval is 10 seconds. If the threshold value is 30 seconds, communication interval calculation section 207 determines that mobile terminal apparatus 100 was acquiring an information summary most recently.

If it is determined in above step S203 that an information summary has been transmitted most recently, in step S204 operation recognition section 202 recognizes that the next information summary has been requested, selects the next information summary after the information summary distributed most recently, and updates latest information distribution history recording section 206. Selection of the next information summary can be performed by incrementing the information ID by 1, for example. If information IDs are not consecutive due to deletion or the like, the next existing information ID is searched for. If the maximum value of currently existing information IDs is exceeded, operation recognition section 202 returns to the beginning.

If it is determined in above step S203 that an information summary has not been transmitted most recently, in step S205 information selection section 203 selects the first information summary as an information summary to be transmitted, and updates latest information distribution history recording section 206.

In step S206, information distribution apparatus 200 transmits the information summary selected in above step S204 or S205 to mobile terminal apparatus 100 (see number 152). Specifically, information reading section 204 reads the selected information summary, distribution-side communication section 201 transmits the information summary read by information reading section 204 to mobile terminal apparatus 100, and communication interval calculation section 207 updates latest acquisition time history recording section 208.

In step S102, terminal-side communication section 101 of mobile terminal apparatus 100 receives the information summary transmitted from information distribution apparatus 200 by means of short-range radio communication.

In step S103, display section 103 displays the information summary received in above step S102.

During execution of the above processing flow, a user can select a different course for information summary acquisition, and obtain a desired result, by performing an appropriate operation (action).

Here, an “action” in this embodiment is a generic term for various kinds of user behavior, and typically means a “gesture” such as waving of mobile terminal apparatus 100 by the user. A user action (gesture) makes use of the fact that distribution-side communication section 201 of information distribution apparatus 200 uses short-range communication and is directional. That is to say, in this embodiment, after communication has been established between terminal-side communication section 101 and distribution-side communication section 201, a user reflects a user action (gesture) in information summary acquisition, selection, termination, continuation, and so forth, by performing an action (gesture) such as to be or not be short-range or directional. This is advantageous in terms of cost reduction due to the fact that an actual sensor is unnecessary, as well as cost reduction and ease of introduction (implementation) attributable to the fact that modification of an existing system is not required. User actions (gestures) may be detected by sensors such as an acceleration sensor and location sensor installed inside mobile terminal apparatus 100.

(1) If the user does not show interest in a received information summary, and does not wish to receive another information summary, the user performs an action for non-necessity of information summary acquisition (for example, leaving the location, or ignoring the summary information and executing another function of mobile terminal apparatus 100), and information acquisition ends.

(2) If the user does not show interest in a received information summary, but wishes to receive another information summary, the user performs an action for information summary acquisition. For example, the user first terminates information acquisition and cuts communication by removing mobile terminal apparatus 100 from information distribution apparatus 200 (step S104: NO), and then starts communication again by holding mobile terminal apparatus 100 over information distribution apparatus 200 once again. In this way, the user can view information summaries in succession simply by removing mobile terminal apparatus 100 from, and holding mobile terminal apparatus 100 over, information distribution apparatus 200.

(3) If the user shows interest in an information summary displayed by display section 103, the user continues communication by continuing to hold mobile terminal apparatus 100 over information distribution apparatus 200 (step S104: YES).

In step S105, terminal-side communication section 101 of mobile terminal apparatus 100 transmits a communication continuation notification to information distribution apparatus 200 (see number 153).

In step S106, terminal-side communication section 101 determines whether or not information has been received from information distribution apparatus 200. If the result of this determination is that information has been received, information acquisition is terminated, whereas if the result of this determination is that information has not been received, the processing flow returns to above step S104.

The transmission of a communication continuation notification in above step S105 is executed at predetermined intervals. This interval is a value arranged with information distribution apparatus 200 beforehand.

On the other hand, when information distribution apparatus 200 transmits the information summary selected in above step S206 to mobile terminal apparatus 100 (see number 152), information distribution apparatus 200 performs determination of communication continuation in step S207. If the result of this determination is not “communication continuation,” the processing flow returns to above step S201 and the request standby state, whereas if the result of this determination is “communication continuation,” the processing flow proceeds to step S208.

In step S208, distribution-side communication section 201 of information distribution apparatus 200 receives a communication continuation notification from mobile terminal apparatus 100. This communication continuation notification is the signal transmitted to information distribution apparatus 200 by mobile terminal apparatus 100 in above step S105 (see number 153).

As stated above, the transmission of a communication continuation notification in above step S105 is executed at predetermined intervals, and this interval has been arranged with information distribution apparatus 200 beforehand. In the event of not having received a communication continuation notification after this interval has elapsed, information distribution apparatus 200 determines that communication has not been continued (step S207: NO).

When mobile terminal apparatus 100 transmits a communication continuation notification in above step S105, information distribution apparatus 200 receives the communication continuation notification in above step S208.

In step S209, duration calculation section 209 of information distribution apparatus 200 calculates the duration of the communication, and determines whether or not the calculated communication duration is greater than or equal to a fixed time. In calculating the communication duration, duration calculation section 209 uses the latest start time history recorded in latest start time history recording section 210. The communication duration threshold value may be a value set beforehand, or a value set for each information summary may be used.

If the communication duration is not greater than or equal to the fixed time, distribution-side communication section 201 transmits a communication continuation acceptance to mobile terminal apparatus 100 in step S210 (see number 154), returns to above step S207, and continues communication continuation determination.

If duration calculation section 209 confirms continuation of communication for the fixed time or longer in above step S209, the processing flow proceeds to step S211.

In step S211, operation recognition section 202 recognizes that transmission of information corresponding to the information summary transmitted immediately previously has been requested, and information selection section 203 selects information corresponding to the information summary distributed most recently. Information reading section 204 reads the information selected by information selection section 203, and distribution-side communication section 201 transmits the information read by information reading section 204 to mobile terminal apparatus 100 (see number 155). Then information distribution apparatus 200 returns to the request standby state in above step S201.

In step S106, terminal-side communication section 101 of mobile terminal apparatus 100 determines whether or not information has been received from information distribution apparatus 200. If the result of this determination is that information has been received, information acquisition is terminated, whereas if the result of this determination is that information has not been received, the processing flow returns to above step S104. That is to say, mobile terminal apparatus 100 terminates information acquisition on receiving information selected based on information corresponding to the information summary distributed most recently.

As described in detail above, according to this embodiment, mobile terminal apparatus 100 is provided with terminal-side communication section 101 that performs directional short-range radio communication with information distribution apparatus 200, and control section 102 determines a user operation based on communication sensitivity of terminal-side communication section 101, and, based on determined user operation information, controls continuation and termination of information acquisition by terminal-side communication section 101, and issuance of a new information acquisition request to information distribution apparatus 200. On the other hand, information distribution apparatus 200 is provided with distribution-side communication section 201 that performs directional short-range radio communication with mobile terminal apparatus 100, and operation recognition section 202 recognizes a user operation from communication contents received by distribution-side communication section 201. Then information selection section 203 selects distribution information to be read from information storage section 205 by information reading section 204 based on that recognition result, and distribution-side communication section 201 transmits the selected and read distribution information to mobile terminal apparatus 100.

In this way, a user can view a desired information summary simply by means of an operation such as holding mobile terminal apparatus 100 over, or removing mobile terminal apparatus 100 from, information distribution apparatus 200. Furthermore, the user can continuously acquire information corresponding to a displayed information summary by continuing to hold mobile terminal apparatus 100 over information distribution apparatus 200. Also, if a displayed information summary is not required, the user can acquire the next information summary prepared by information distribution apparatus 200 from information distribution apparatus 200 by means of an operation such as twisting (by a turn of the wrist) mobile terminal apparatus 100 held in the user's hand. Similarly, if the user wishes to stop or interrupt reception of information distribution, the user need only perform an operation such as moving mobile terminal apparatus 100 away from information distribution apparatus 200.

In this embodiment, information distribution apparatus 200 needs only identify mobile terminal apparatus 100 until a user acquires information while standing before information distribution apparatus 200 and after viewing an information summary, after which information distribution apparatus 200 may forget that mobile terminal apparatus 100. Consequently, a terminal ID may be a temporary one, and as long as provision is made for a terminal ID to be issued on a case-by-case basis, a user who does not want his/her terminal to be identified by a terminal ID can also use the system with peace of mind.

It is not necessary for all histories to be held for all terminals, and a history may be deleted after information has been acquired or after a certain time has elapsed. This reduces the burden on information distribution apparatus 200 of storing histories, and retrieving necessary information from numerous histories, while also eliminating any concern a user may have as to how long histories will be kept.

The method of recognizing a user operation is not limited to that described above, and an operation may also be recognized by means of another method. For example, determination of a communication interval need not be based on “latest” or “not latest” criteria, and it is also possible to use multi-stage criteria, such as “extremely short,” “short,” “long,” and so forth, and to recognize a different operation and change the processing when, for instance, a mobile terminal apparatus is held over/removed from an information distribution apparatus for two successive “short” intervals.

Provision may also be made for left→right and up→down operations to be recognized by providing a plurality of short-range radio communication antennas. With this method, operations such as returning to a previous information summary rather than proceeding to the next one, or skipping on a genre-by-genre basis, are possible.

Provision may also be made for information viewing to be performed by providing a separate proximity sensor or distance sensor, and detecting shortness of distance or increased proximity. In this case, an information provision system can be constructed in which power consumption is suppressed by supplying radio power after a mobile terminal apparatus has been detected as being held over an information distribution apparatus for a longish time.

### Embodiment 2

Communication sensitivity is essentially information as to whether communication is possible, or is not possible because of an out-of-range situation. In Embodiment 1, a user operation is determined by information distribution apparatus 200. Mobile terminal apparatus 100 issues an information summary request when connected, and then, if still connected, issues a continuation request.

In Embodiment 2, a user operation is determined by a mobile terminal apparatus, which makes a request for processing to an information distribution apparatus. A mobile terminal apparatus of Embodiment 2, when connected, calculates a communication interval with respect to the previous communication, and also calculates the duration of continuous connection. Embodiment 2 is an aspect of the present invention in which an above-described determination section of Embodiment 1 is moved from an information distribution apparatus to a mobile terminal apparatus.

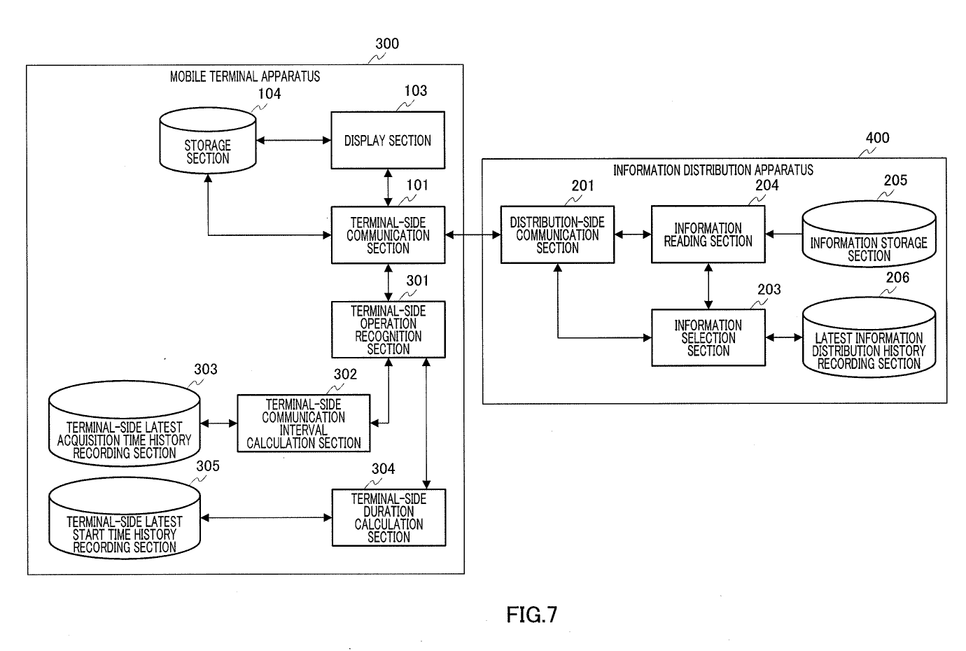

FIG. 7 is a block diagram showing configurations of a mobile terminal apparatus and an information distribution apparatus according to Embodiment 2 of the present invention. Configuration parts in FIG. 7 identical to those in FIG. 2 are assigned the same reference codes as in FIG. 2, and duplicate descriptions are omitted.

In FIG. 7, an information distribution system comprises mobile terminal apparatus 300 provided with a short-range radio communication function, and information distribution apparatus 400 that distributes information to mobile terminal apparatus 300 by means of a short-range radio communication function.

Mobile terminal apparatus 300 comprises terminal-side communication section 101, display section 103, storage section 104, terminal-side operation recognition section 301, terminal-side communication interval calculation section 302, terminal-side latest acquisition time history recording section 303, terminal-side duration calculation section 304, and terminal-side latest start time history recording section 305.

Information distribution apparatus 400 comprises distribution-side communication section 201, information selection section 203, information reading section 204, information storage section 205, and latest information distribution history recording section 206.

As compared with mobile terminal apparatus 100 in FIG. 2, mobile terminal apparatus 300 additionally comprises terminal-side operation recognition section 301, terminal-side communication interval calculation section 302, terminal-side latest acquisition time history recording section 303, terminal-side duration calculation section 304, and terminal-side latest start time history recording section 305. As compared with information distribution apparatus 200 in FIG. 2, information distribution apparatus 400 lacks operation recognition section 202, communication interval calculation section 207, latest acquisition time history recording section 208, duration calculation section 209, and latest start time history recording section 210.

Terminal-side operation recognition section 301 performs user operation recognition based on data received from terminal-side communication section 101, terminal-side communication interval calculation section 302, and terminal-side duration calculation section 304.

Terminal-side communication interval calculation section 302 calculates a communication interval using a terminal-side latest information distribution history of terminal-side latest acquisition time history recording section 303.

Terminal-side latest acquisition time history recording section 303 records a time at which an information summary was last received from information distribution apparatus 400 as a terminal-side latest acquisition time history.

Terminal-side duration calculation section 304 calculates the duration of communication using a terminal-side latest start time history of terminal-side latest start time history recording section 305.

Terminal-side latest start time history recording section 305 records a time at which communication was last started with information distribution apparatus 400 as a terminal-side latest start time history.

FIG. 8 is a drawing showing an example of the data structure of a terminal-side latest acquisition time history recorded in terminal-side latest acquisition time history recording section 303.

In FIG. 8, terminal-side latest acquisition time history 303A records an apparatus ID and a time at which an information summary was last acquired from an information distribution apparatus corresponding to that apparatus ID. For example, the first line in FIG. 8 shows that the time at which an information summary was last acquired from an information distribution apparatus whose apparatus ID is “a” is “2008/12/31 10:00:04.”

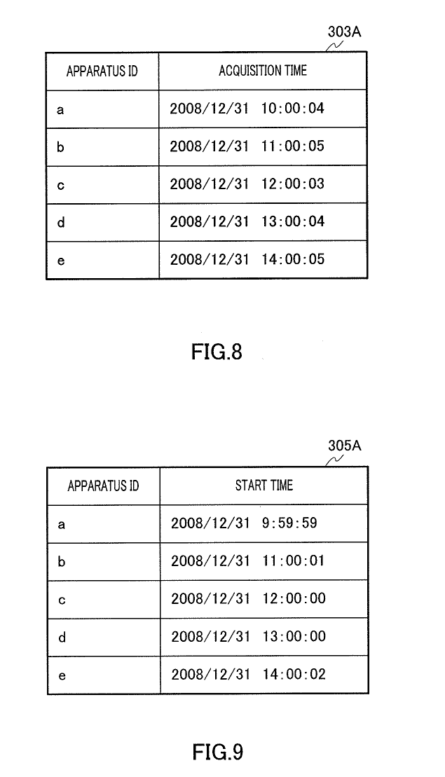

FIG. 9 is a drawing showing an example of the data structure of a terminal-side latest start time history recorded in terminal-side latest start time history recording section 305.

In FIG. 9, terminal-side latest start time history 305A records an apparatus ID and a time at which communication with an information distribution apparatus corresponding to that apparatus ID was last started. For example, the first line in FIG. 9 shows that the time at which communication was last started with an information distribution apparatus whose apparatus ID is “a,” is “2008/12/31 9:59:59.”

The operation of mobile terminal apparatus 300 and information distribution apparatus 400 configured as described above will now be explained.

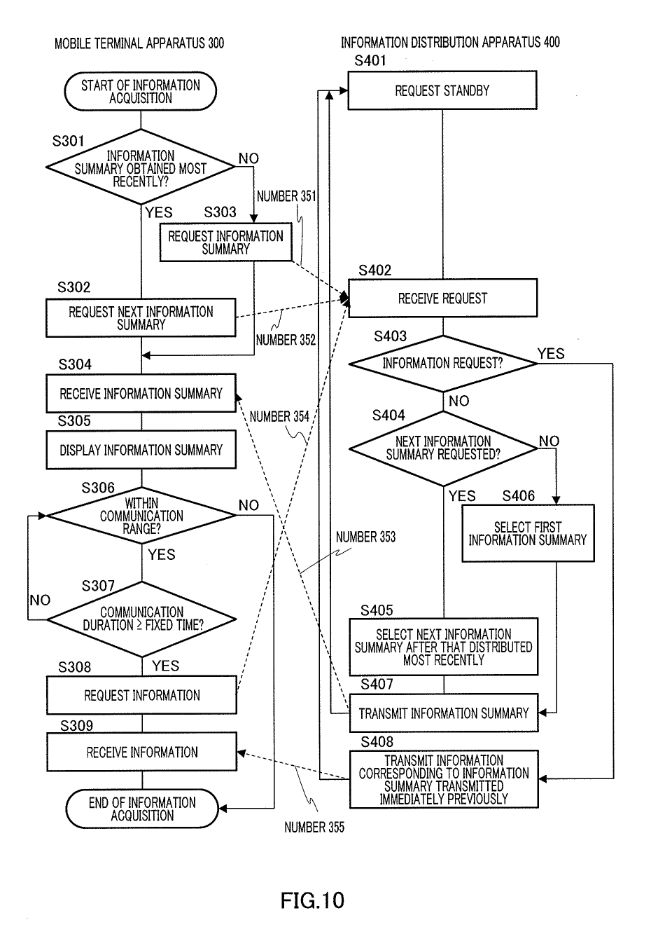

FIG. 10 is a flowchart showing the operation of mobile terminal apparatus 300 and information distribution apparatus 400. In FIG. 10, reference codes S301 through S309 indicate operations on the mobile terminal apparatus 300 side, and reference codes S401 through S408 indicate operations on the information distribution apparatus 400 side. Numbers 351 through 355 indicate signal transmission/reception between mobile terminal apparatus 300 and information distribution apparatus 400. The flowchart in FIG. 10 is executed by control sections comprising a CPU or the like (not shown) of mobile terminal apparatus 300 and information distribution apparatus 400.

First, when the user holds mobile terminal apparatus 300 close to information distribution apparatus 400 and starts communication, information acquisition starts.

In step S301, mobile terminal apparatus 300 determines whether or not it has obtained an information summary most recently. A specific example is similar to that in Embodiment 1.

If the result of the determination in step S301 is that an information summary has been obtained most recently, in step S302 mobile terminal apparatus 300 requests the next information summary, whereas if the result of this determination is that an information summary has not been obtained most recently, in step S303 mobile terminal apparatus 300 simply requests an information summary. Here, “simply” means that there is no specification of “next,” and means “the first,” so to speak. Specifically, terminal-side communication section 101 of mobile terminal apparatus 300 makes a request for an information summary to distribution-side communication section 201 of information distribution apparatus 200 by means of short-range radio communication (see numbers 351 and 352).

When not communicating with any mobile terminal, information distribution apparatus 400 is in a request standby state (step S401).

When mobile terminal apparatus 300 transmits a request, information distribution apparatus 400 receives an information summary request in step S402. Such request reception includes an information summary request (see number 351), a next information summary request (see number 352), and a request for information after the elapse of a fixed time within the communication range (see number 354).

In step S403, information distribution apparatus 400 determines whether or not a request is an information request.

If the result of the determination in above step S403 is that a request is not an information request, the processing flow proceeds to step S404, whereas if the result of this determination is that a request is an information request, the processing flow proceeds to step S408. Initially, a request is not an information request but an information summary request, and therefore the processing flow proceeds to step S404.

In step S404, information distribution apparatus 400 determines whether or not mobile terminal apparatus 300 is requesting the next information summary.

If the result of the determination in above step S404 is that mobile terminal apparatus 300 is requesting the next information summary, in step S405 information distribution apparatus 400 selects the next information summary after the one distributed most recently, and proceeds to step S407. On the other hand, if the result of the determination in above step S404 is that mobile terminal apparatus 300 is not requesting the next information summary, in step S406 information distribution apparatus 400 selects the first information summary, and proceeds to step S407.

In step S407, information distribution apparatus 400 transmits the selected information summary—either the next information summary after the one distributed most recently, selected in above step S405, or the first information summary, selected in above step S406—to mobile terminal apparatus 300 (see number 353), and returns to above step S401.

If the result of the determination in above step S403 is that a request is an information request, in step S408 information distribution apparatus 400 transmits information corresponding to the information summary transmitted immediately previously (see number 355), and returns to above step S401.

On the other hand, mobile terminal apparatus 300 proceeds with the following processing.

In step S304, mobile terminal apparatus 300 receives an information summary.

In step S305, mobile terminal apparatus 300 displays the information summary received in above step S304.

In step S306, mobile terminal apparatus 300 determines whether or not it is within the communication range, and if it is outside the communication range, terminates information acquisition. If it is within the communication range, in step S307 mobile terminal apparatus 300 determines whether or not the communication duration is greater than or equal to a fixed time.

If the result of the determination in above step S306 is that the communication duration has not exceeded the fixed time, mobile terminal apparatus 300 returns to above step S306, and continues determination of whether it is within the communication range.

If the determination in above step S306 is that the communication duration has exceeded the fixed time, in step S308 mobile terminal apparatus 300 makes a request for information to information distribution apparatus 400 (see number 354).

In step S309, mobile terminal apparatus 300 receives information from information distribution apparatus 400 (see number 355), and terminates this information acquisition processing.

Thus, in this embodiment, mobile terminal apparatus 300 is further provided with terminal-side latest acquisition time history recording section 303 that records the time of the latest acquisition of information from information distribution apparatus 400, terminal-side communication interval calculation section 302 that calculates the latest communication interval with information distribution apparatus 400, terminal-side latest start time history recording section 305 that records a start time at which the latest communication with information distribution apparatus 400 was started, and terminal-side duration calculation section 304 that calculates the duration of the latest communication with information distribution apparatus 400; and terminal-side operation recognition section 301 recognizes a user operation based on the information acquisition time, communication interval, and communication start time and duration, and, based on recognized user operation information, controls continuation and termination of information acquisition by terminal-side communication section 101, and issuance of a new information acquisition request to information distribution apparatus 400.

In this way, as with Embodiment 1, a user can view a desired information summary simply by means of an operation such as holding mobile terminal apparatus 300 over, or removing mobile terminal apparatus 300 from, information distribution apparatus 400. Furthermore, the user can continuously acquire information corresponding to a displayed information summary by continuing to hold mobile terminal apparatus 300 over information distribution apparatus 400.

Also, in this embodiment, information distribution apparatus 400 has a configuration in which operation recognition section 202, communication interval calculation section 207, latest acquisition time history recording section 208, duration calculation section 209, and latest start time history recording section 210 of information distribution apparatus 200 in FIG. 2 have been eliminated, enabling information distribution apparatus 400 to be configured by means of a general-purpose system. Consequently, it is possible to provide information to any kind of terminal. That is to say, this information distribution system enables information to be distributed to a terminal irrespective of the type or version of that terminal.

The above description presents examples of preferred embodiments of the present invention, but the scope of the present invention is not limited to these. For example, in the above embodiments, examples have been described in which a mobile phone is used as a mobile terminal apparatus, but a mobile terminal apparatus is not limited to a mobile phone, and the present invention can also be applied to a mobile information terminal such as a PDA, a portable audiovisual device, portable game machine, or personal computer provided with a short-range radio communication function, an apparatus combining these, and so forth.

In these embodiments, the terms “mobile terminal apparatus,” “information distribution apparatus,” “information distribution system,” and “information distribution method” have been used, but this is simply for convenience of description, and terms such as “mobile terminal” and “information display method” may, of course, also be used for an apparatus and method respectively.

The type, number, connection method, and so forth of circuit sections—for example, a storage section or the like—configuring an above-described mobile terminal apparatus and information distribution apparatus, are not limited to those in the above embodiments.

An above-described mobile terminal apparatus and information distribution apparatus are implemented by means of a program for causing this mobile terminal apparatus and information distribution apparatus to function in addition to electrical circuitry. This program is stored in a computer-readable storage medium.

The disclosure of Japanese Patent Application No. 2008-100596, filed on Apr. 8, 2008, including the specification, drawings and abstract, is incorporated herein by reference in its entirety.

### INDUSTRIAL APPLICABILITY

A mobile terminal apparatus, information distribution apparatus, information distribution system, and information distribution method according to the present invention enable a user to perform information summary viewing and information acquisition easily, such as when carrying luggage on a trip, for instance, by means of operations whereby the user's terminal is held close to, removed from, or continuously held over an information distribution apparatus installed in a store or the like that performs information distribution using short-range radio communication, and are useful as an information distribution method. The present invention is also suitable for use in mobile terminal apparatuses and mobile electronic devices such as mobile phones equipped with a short-range radio communication function. It is also possible for the present invention to be incorporated in an electronic device such as a mobile phone as a control program.

### REFERENCE SIGNS LIST

100, 300 Mobile terminal apparatus
101 Terminal-side communication section
102 Control section
103 Display section
104 Storage section
200, 400 Information distribution apparatus
201 Distribution-side communication section
202 Operation recognition section
203 Information selection section
204 Information reading section
205 Information storage section
206 Latest information distribution history recording section
207 Communication interval calculation section
208 Latest acquisition time history recording section
209 Duration calculation section
210 Latest start time history recording section
301 Terminal-side operation recognition section
302 Terminal-side communication interval calculation section
303 Terminal-side latest acquisition time history recording section
304 Terminal-side duration calculation section
305 Terminal-side latest start time history recording section

1. A mobile terminal apparatus comprising:
a short-range radio communication section that performs directional short-range radio communication with an information distribution apparatus;
a display section that displays information received by the short-range radio communication section; and
a control section that determines a user operation based on communication sensitivity of the short-range radio communication section, and, based on determined user operation information, controls continuation and termination of information acquisition by the short-range radio communication section, and issuance of a new information acquisition request to the information distribution apparatus.

2. A mobile terminal apparatus comprising:
a short-range radio communication section that performs directional short-range radio communication with an information distribution apparatus;
a display section that displays information received by the short-range radio communication section;
an operation recognition section that recognizes a user operation based on communication sensitivity of the short-range radio communication section, and, based on recognized user operation information, controls continuation and termination of information acquisition by the short-range radio communication section, and issuance of a new information acquisition request to the information distribution apparatus;
a latest acquisition time history recording section that records a latest acquisition time of information from the information distribution apparatus;
a communication interval calculation section that calculates a latest communication interval with the information distribution apparatus;
a latest start time history recording section that records a start time at which a latest communication with the information distribution apparatus was started; and
a duration calculation section that calculates a duration of a latest communication with the information distribution apparatus,
wherein the operation recognition section recognizes a user operation based on the information acquisition time, the communication interval, the communication start time, and the duration.

3. An information distribution apparatus comprising:
an information storage section that stores distribution information;
a short-range radio communication section that performs directional short-range radio communication with a mobile terminal apparatus;
an operation recognition section that recognizes a user operation from communication contents received by the short-range radio communication section; and
an information selection section that selects distribution information stored in the information storage section based on a recognition result of the operation recognition section,
wherein the short-range radio communication section transmits distribution information selected by the information selection section to the mobile terminal apparatus.

4. An information distribution apparatus comprising:
an information storage section that stores distribution information;
a short-range radio communication section that performs directional short-range radio communication with a mobile terminal apparatus; and
an information selection section that selects distribution information stored in the information storage section in accordance with a request from the mobile terminal apparatus,
wherein the short-range radio communication section transmits distribution information selected by the information selection section to the mobile terminal apparatus.

5. The information distribution apparatus according to claim 3, wherein, when the operation recognition section recognizes that a user operation is a next information request operation by the user, the information selection section selects next information after information distributed most recently from among distribution information stored in the information storage section.

6. The information distribution apparatus according to claim 3, further comprising a latest information distribution history recording section that records a latest information distribution history transmitted last to the mobile terminal apparatus,
wherein when the operation recognition section recognizes that a user operation is an information continuation request operation by the user, the information selection section selects information recorded in the latest information distribution history recording section.

7. The information distribution apparatus according to claim 3, further comprising:
a latest acquisition time history recording section that records a latest acquisition time of information from the information distribution apparatus; and
a communication interval calculation section that calculates a latest communication interval with the mobile terminal apparatus,
wherein the operation recognition section recognizes a user operation based on the information acquisition time and the communication interval.

8. The information distribution apparatus according to claim 3, further comprising:
a latest start time history recording section that records a start time at which a latest communication with the mobile terminal apparatus was started; and
a duration calculation section that calculates a duration of a latest communication with the mobile terminal apparatus,
wherein the operation recognition section recognizes a user operation based on the communication start time and the duration.

9. The information distribution apparatus according to claim 4, wherein, when communication contents received by the short-range radio communication section are a next information request operation by a user, the information selection section selects next information after information distributed most recently from among distribution information stored in the information storage section.

10. The information distribution apparatus according to claim 4, further comprising a latest information distribution history recording section that records a latest information distribution history transmitted last to the mobile terminal apparatus,
wherein, when communication contents received by the short-range radio communication section are an information continuation request operation by a user, the information selection section selects information recorded in the latest information distribution history recording section.

11. An information distribution system having a mobile terminal apparatus and an information distribution apparatus that distributes information in response to a request from the mobile terminal apparatus, wherein:
the mobile terminal apparatus has:
a short-range radio communication section that performs directional short-range radio communication with an information distribution apparatus;
a display section that displays information received by the short-range radio communication section; and
a control section that determines a user operation based on communication sensitivity of the short-range radio communication section, and, based on determined user operation information, controls continuation and termination of information acquisition by the short-range radio communication section, and issuance of a new information acquisition request to the information distribution apparatus;
the information distribution apparatus has:
an information storage section that stores distribution information;
a distribution-side short-range radio communication section that performs directional short-range radio communication with the mobile terminal apparatus;
an operation recognition section that recognizes a user operation from communication contents received by the distribution-side short-range radio communication section; and
an information selection section that selects distribution information stored in the information storage section based on a recognition result of the operation recognition section; and
the distribution-side short-range radio communication section transmits distribution information selected by the information selection section to the mobile terminal apparatus.

12. An information distribution method that is an information distribution method of distributing information from an information distribution apparatus in response to a request from a mobile terminal apparatus, the information distribution method comprising:
on the mobile terminal apparatus side,
performing directional short-range radio communication with the information distribution apparatus;
displaying information received by means of the short-range radio communication;
determining a user operation based on communication sensitivity of the short-range radio communication; and
controlling, based on determined user operation information, continuation and termination of information acquisition by the short-range radio communication section, and issuance of a new information acquisition request to the information distribution apparatus; and
on the information distribution apparatus side,
storing distribution information;
performing directional short-range radio communication with the mobile terminal apparatus;
recognizing a user operation from communication contents received by means of the short-range radio communication;
selecting stored distribution information based on the recognition result; and
transmitting selected distribution information to the mobile terminal apparatus.
